(19) United States
(12) Patent Application Publication
(10) Pub. No.: US 2011/0046985 A1
(43) Pub. Date: Feb. 24, 2011

(54) A novel method of underwriting and implementing low premium health insurance for globalizing healthcare

(76) Inventor: Fazal Raheman, Dubai (AE)

Correspondence Address: Fazal Raheman, Suite 217, Twin Towers, P. Box 4404, Dubai, 4404, AE

(21) Appl. No.: 12/503,668

(22) Filed: Aug. 20, 2009

(51) Int. Cl. G06Q 40/00

(52) U.S. Cl. 705/4

(57) ABSTRACT

A novel method and apparatus for effectuating outsourcing components of the complex processes of underwriting, implementation and administration of a novel low cost healthcare delivery plan to offshore locations, comprising of a computer network of plurality of computer terminals that integrate the conventional processes with new processes that allow seamless implementation of home country emergency inpatient and essential healthcare services, with low cost offshore services that include, i) elective medical procedures performed at offshore accredited hospitals, ii) back office administrative support, ii) 24/7 customer support, iii) 24/7 online physician support, iv) importation and home delivery of approved prescription drugs, and v) travel support to the offshore destination.

The method discloses first ever computer/apparatus that enables two disparate transnational insurance systems to deploy their different algorithms to output a single low health insurance premium to the healthcare buyers, and enables an open marketplace for insurance/reinsurance underwriters, brokers, caregivers and facilitators.

### STATEMENT REGARDING FEDERALLY SPONSORED RESEARCH OR DEVELOPMENT

Not Applicable

### REFERENCE TO A MICROFICHE APPENDIX

Not Applicable

### TECHNICAL FIELD

The present invention relates to an innovative Information Technology enabled method of executing a complex business method via novel network architecture that enables seamless integration of plurality of remote computer and communication device terminals. The invention particularly facilitates the new and rapidly evolving medical tourism industry by enabling insurance companies to offer low cost group health insurance to employers and consumer driven health insurance plans to beneficiaries who are willing to travel overseas for any of the major elective medical procedures that are warranted. The method actively engages such diverse industries as healthcare, insurance, offshoring, travel and hospitality, and implements through process-enabling apparatuses.

### BACKGROUND OF THE INVENTION

Traditionally, employers in the United States, provide health care or medical insurance to their employees and to the employee's family and dependents. This is done in one of two ways: either through a commercial group health care insurance policy, or by self insuring the employees so that health care expenses are reimbursed through an employer fund. However, due to the very high costs of health insurance plans, some employers, particularly small businesses, do not offer any health or medical insurance benefit to employees, in which case the employee may be on his/her own to procure health care or medical insurance coverage without any monetary contribution from the employer. Despite several legislative initiatives from US lawmakers over the years, neither the healthcare costs have stopped their escalation, nor has the percentage of uninsured Americans declined. According to a recent report by the US Institute of Medicine, the US health insurance system is in a state of crisis (Editorial. The USA's crisis of the uninsured. The Lancet, Volume 373, Issue 9666, Page 782, 7 Mar. 2009). A complete lack of health insurance has potentially devastating consequences in about 47 million uninsured Americans. The current state of healthcare in US is principally attributed to the exorbitant costs of health insurance that are further expected to double within the next 7-8 years from today's average of $12,700 to a mindboggling $24,000 per insured per annum.

In 1986, US Congress enacted the “Consolidated Omnibus Budget Reconciliation Act of 1985”, which has become known as COBRA. COBRA gives certain workers and their families the right to keep their group health insurance for a specified period of time after they leave their employer's plan. The law applies to most individuals who have participated in employer sponsored group benefit programs, and attempts to provide some measure of protection for workers and their families who have lost their insurance because of changes in their work or family life, such as losing a job or getting divorced. COBRA contains provisions that enable individuals who loose their health insurance due to a disability to continue coverage for 29 months. When an employer terminates an employee, the employee, if he has been a participant in the employer-sponsored group health insurance plan, has the right to continue his group health insurance coverage under COBRA. However, the terminated participant typically must pay the entire premium (monthly payment) for his coverage under the group plan, including the substantial portion previously paid by the employer; the employer no longer pays a share of the health insurance costs for the terminated participant. With the rise in insurance costs, however, COBRA premiums have themselves become prohibitively expensive, totaling nearly $13,000 in 2007 for a family policy, according to the Kaiser Family Foundation. For example, if a beneficiary's group health plan's cost for family coverage is $1,000 each month, while employed the beneficiary may have paid $300 each month, and the employer would have paid the remaining $700. If the beneficiary thereafter is terminated and is disabled, and if he qualifies under COBRA provisions or the equivalent state law for health care benefits, he thereafter must pay the entire $1,000 himself. The participant also may be charged up to 2% more than the premiums to administer the plan, in which case the COBRA premium could be $1,020 instead of $300 that he was paying as an employee. Therefore the COBRA protection although guarantees the continuation of the policy, makes it prohibitive for the unemployed beneficiary to maintain. So the namesake COBRA law had done nothing to make healthcare accessible.

Recently legislated American Recovery and Reinvestment Act of 2009 allocated $24.7 billion to provide a 65 percent subsidy of health care insurance premiums for the unemployed under the COBRA program. Even after 65% government subsidy the beneficiary's net monthly payment of the policy premium which he is required to pay still increases over the amount he was actually paying during his employment.

The High Deductible Health Plan (HDHP) is a relatively new health plan product that became available through recent federal legislation and which may be combined with a Health Savings Account (HSA) or a Health Reimbursement Arrangement (HRA) to provide insurance coverage and a tax-advantaged way to help save for future medical expenses. The HDHP with an HSA or HRA gives the account holder some flexibility and discretion over how one uses one's health care dollars. However, recent reports indicate that HSA hasn't really been utilized by masses for its intended purpose.

“Healthcare reform cannot wait, it must not wait, and it will not wait another year.” With those words, President Barack Obama, in his first address to a joint session of Congress, rallied Congress and the American people to tackle the “crushing cost of healthcare.” Yet, nothing in Obama administration' arsenal has anything to tackle “one of the most wasteful sectors of healthcare—the health insurance industry.” (Nancy R Terri. The Ponzi scheme that is health insurance. Medscape.com, www.medscape.com/viewarticle588861?src=top10 accessed Apr. 3, 2009).

Insurers and providers spend tens of billions a year nationally on insurance-related paperwork that does not contribute to the quality of care. US healthcare industry spends significantly more for every dollar of actual patient care than any other country in the world. A research conducted by Kahn et al Concluded that of the total insurance premiums used to cover hospital and physician care, 21 percent is spent on insurance administration. Another 13 percent is used to cover other administrative tasks. Only 66 percent is used for patient care. (Kahn James et al. The Cost Of Health Insurance Administration In California: Estimates For Insurers, Physicians, And Hospitals. Health Affairs, 24: no. 6; 1629-1639, 2005.). Of the 66 cents of every health insurance policy premium dollar, an estimated 16 cents are spent on the prescription drugs. The remaining 50 cents is almost equally divided between inpatient and outpatient care. (http://findartices.com/p/articles/mi_m0BPC/is_{—}8_{—}27/ai_{—}107199465 accessed Apr. 3, 2009).

Rosenberg et al (N Engl J Med. Nov. 16, 1995; 333(20):1326-30) studied a New York cohort of 7445 fee-for-service insurance plan enrollees who called for inpatient services. Only 10.55% of all hospital admissions were on account of medical emergencies (http://content.nejm.org/cgi/contentful/333/20/1326, accessed Apr. 3, 2009). However, when accounting for the total hospital days approved for inpatient insurance coverage, only 286 days of the total 20,792 hospital days (about 1.4%) were claimed for emergency admissions. In other words 98.4% of the approved hospital days were for elective procedures. Elective procedures constitute a major chunk of all inpatient activities and more importantly constitute over 98% of the hospital days paid by the health insurance companies. (Rosenberg S N et al. Effect of Utilization Review in a Fee-for-Service Health Insurance Plan. N Engl J Med. Nov. 16, 1996; 333(20):1326-30).

Despite all the US government efforts, the trends show that there is no relief in sight from the perennially rising costs of health insurance. As a consequence of such a state of health care in the United States consumers, in recent years, has resorted to Medical Tourism.

In much of the rest of the developed world the healthcare industry is little different than that of US, and Medical Tourism is sought for entirely different reasons. In Canada and Europe the healthcare is more or less socialized and free to all citizens as a matter of right. However, in most cases the waiting periods for elective procedures is so long that patients are resorting to Medical Tourism for quicker access to quality medical treatment offshore. This is despite the fact that the patient may not obtain proper follow up and monitoring after returning home, and the fact that the foreign facilities and practitioners may not meet the same standards that the patient would see in home country. Many patients feel that the quicker services outweigh the risks.

Medical tourism is the rapidly-growing practice of traveling across international borders to obtain health care. Such services typically include elective procedures as well as complex specialized surgeries such as joint replacement (knee/hip), cardiac surgery, hysterectomies, breast biopsies and mastectomies, dental procedures, and cosmetic surgeries. However, virtually every type of health care, including psychiatry, alternative treatments, convalescent care and even burial services can be made available. Medical Tourism is a phenomenon of very recent origin. Over 50 countries have identified medical tourism as a national industry. The industry is still evolving albeit at a very fast pace. In 2007 medical tourism generated $60 billion in revenues mostly in Asian countries such as India, Thailand, Singapore, Malaysia and China. It is expected to be a $100 billion dollar industry by 2010. Medical Tourism is however not a structured industry yet. Most patient's travel to overseas hospitals for treatment on their own volition and without infrastructure support or insurance coverage. For years the healthcare providers in US have been very critical of quality of healthcare overseas. But the recent spurt in Americans travelling overseas for treatment of elective medical procedures has faulted that notion.

In medical tourism, as a practical matter, providers and customers commonly use informal channels of communication-connection-contract, and in such cases this tends to mean less regulatory or legal oversight to assure quality and less formal recourse to reimbursement or redress, if needed. It also means that such unstructured scheme of treatment for elective medical procedures offshore is outside the cover of the traditional health insurance plans and reimbursement in most cases is not automatic and impossibly cumbersome.

Currently there is no health insurance market for availing treatment of elective medical procedures overseas (TEMPO). The most complicated aspect of any insurance business is the underwriting of policies. Using a wide assortment of data, insurers predict the likelihood that a claim will be made against their policies and price products accordingly. To this end, insurers use actuarial science to quantify the risks they are willing to assume and the premium they will charge to assume them. Health insurance practice in US and most countries with privatized healthcare is logistically different from other conventional insurances in the sense that the claim to the beneficiary is delivered through an affiliate hospital, and the beneficiary hardly needs to interact with the insurer. This makes the existing International insurance markets such as the Lloyd's of London only useful for secondary reinsurance activity leaving the caregiver hospitals and end-users out of the loop. Lloyd's members include many syndicates from diverse industry sectors but hardly anyone representing individual hospitals or the policy purchasing patients. More importantly, in Medical Tourism, the caregiver hospital has a location foreign to the usual place of residence of the beneficiary patient, and unaffiliated to the primary insurer. When a major component of the healthcare is outsourced to offshore locations, health insurance policy structuring and underwriting becomes further complex and literally impossible with the prior art approaches. All of these aforementioned circumstances make underwriting medical tourism and integrating within the realms of traditional health insurance coverage a difficult proposition.

Insurance underwriting has a long history, and there is significant prior art in use of Information Technology in this field. For example, U.S. Pat. No. 4,975,840 to DeTore et al., discloses a risk evaluation system for life insurance where computer software automatically provides evaluation data for policy classification. U.S. Pat. No. 4,831,526 to Luchs et al. addresses the need for a system that automates the task of insurance quotation through a system which prepares and writes insurance contracts based upon data provided from clients. In U.S. Pat. No. 4,837,693 Schotz relates to a system which enables employers to gather employee information in order to underwrite, administer and implement a group insurance plan. Schotz relies on a computer system which automatically converts group insurance coverage into individual term contracts based on a database of employee census data which includes, among other things, an employee's name, hiring date, age, birth date, salary, status, and sex. Schotz, however, is solely directed to providing insurance risk adjustments for life insurance.

U.S. Pat. No. 7,319,970 granted to Simone teaches an automatic health and lifestyle analysis computer system, which surveys individual respondents and provides insurability estimates and cost evaluations based upon answers to the surveys. Sherman (U.S. Pat. No. 7,370,000) describes a computer-implemented method for providing additional insurance which is easily-obtainable and affordable to an insured in order for the insured to increase a total benefit of insurance. In U.S. Pat. No. 7,392,201 Binns et al disclose a method for more accurate predictions for health insurance premiums

Recently Grover et al were granted a U.S. Pat. No. 7,490,050 for teaching a rating engine for processing the underwriting information and furnishing real time on-line quote for the insurance premium. More recently Theophilos in a published US Pat App No. 20080300923, described a new concept of lowering the cost of health insurance plan by introducing the concept of “participatory underwriting” by the participating plan members. Using the teachings of the Theophilos method, the members participate in a healthcare program that eventually leads to life style changes and general wellness amongst the members. This reduces the need for medical interventions, consequently resulting in lower premiums for the motivated members. Such lowering of the premium by members own voluntary participation in the program, Theophilos calls “participatory underwriting”. The method however neither results in any significant lowering of health insurance premiums across the board, nor enables medical tourism.

None of the teachings of the prior art deal with the unique and complex circumstances that this invention is set out to tackle. Never encountered anytime before in the history of healthcare or insurance, seamlessly integrating various elements of medical tourism within the health insurance system undoubtedly requires a novel technology platform. It would therefore be an improvement to provide a new method of extending the health insurance facilities to the rapidly growing consumer driven medical tourism industry. However, the instant invention does not merely teach a method and apparatus for conducting insurance business per se, but a comprehensive method of establishing a marketplace for the health insurance underwriters, the healthcare providers, the patient beneficiaries and the various facilitators of outsourced components of healthcare, to interface with each other for delivering the best quality healthcare at the lowest possible cost. The invention described herein thus overcomes the limitations of the prior art.

### SUMMARY OF THE INVENTION

In view of the foregoing, it should be apparent that a need exists for a system and method for a Health Insurance System that integrates rapidly evolving medical tourism and offers quality treatment at lower costs in the process.

Accordingly, there is a need for a method of technology enabled health insurance platform for affording treatment of elective medical procedures overseas. Consequently, it is an advantage of the invention that such a comprehensive method of health insurance system integrates all the front end elements of conventional health insurance plan with the backend intricacies of the policy underwriting, co-underwriting, residual underwriting, premium and claim processing, caregiver and beneficiary interfacing, administrative, travel and hospitality logistics and even drug prescribing, ordering and shipping from offshore locations. As a consequence such implementation of integrated elements relies on the low cost outsourced healthcare delivery chain. The invention overcomes the problems residing in the prior art pertaining to underwriting, implementation and administration of a low cost health insurance for delivering quality healthcare.

It is therefore an object of the present invention to provide a user friendly, portable, highly versatile and yet very expansive, comprehensive and intricate method and apparatus thereof for outsourcing various components of healthcare system from a country with higher costs to a country with substantially lowers costs. It is also an object of the invention to reduce the currently high premiums of group and private health insurance in developed countries by providing means of outsourcing treatment of elective medical procedures offshore to developing countries with high quality healthcare delivery infrastructure. It is still another object of the instant invention to further reduce high health insurance premiums in developed countries by providing means of outsourcing administrative processes pertaining to claim processing and hospital paperwork. It is also another object of the present invention to still further reduce the high group and private insurance premiums in developed countries by providing means of importing and delivering best quality prescription drugs to patient's doorstep through a single platform.

It is further object of the present invention to offer low cost high quality health care insurance coverage to the uninsured in the developed countries. It is still another object of the instant invention to offer substantial savings to the employers and their employees by reducing their health insurance premiums. It is still another object of the instant invention to make conveniently accessible to the patients quality healthcare at overseas hospitals at a significantly lower cost without compromising quality.

It is yet another object of the instant invention to provide apparatus to insurance underwriters for executing entirely new business opportunities for underwriting the portions of healthcare services that are outsourced offshore. It is also an object of the instant invention to enable automatic underwriting of residual insurance of adverse events resulting from adverse events happening during the course of delivering the outsourced portion of the healthcare services.

It is still another object of the instant invention to provide a user-friendly computer interface to all the participants of such a novel health insurance plan ranging from the caregivers, the insurers, the ancillaries such as hospitality and travel and tour operators and the plan beneficiaries. It is therefore an object of the instant invention to provide a single user-friendly technology platform for all the heterogeneous industry components, such as medicine, insurance, hospitality and travel and tourism to operate harmoniously to deliver customer satisfaction at an unprecedented low cost.

It is the eventual object of the instant invention to seamlessly integrate the diverse outsourced lower cost services, such as medical tourism, prescription drug sourcing, online outpatient and physician services support, and the administrative support, into the existing healthcare infrastructure resulting in unprecedented lowering of the cost of delivering quality healthcare to the patients.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results or modifying the invention as will be described. Accordingly, referring to the following drawings may have a complete understanding of the practice of the invention as set forth hereinafter.

### BRIEF DESCRIPTION OF THE SEVERAL VIEWS OF THE DRAWINGS

FIG. 1a is a block diagram illustrating the interplay of various modules in underwriting an Offsurance health insurance plan in a preferred embodiment implemented in a Corporate Buyer scenario.

FIG. 1b is a block diagram illustrating the interplay of various modules in underwriting an Offsurance health insurance plan in a preferred embodiment implemented in a Individual Buyer scenario.

FIG. 2 is a block diagram illustrating the interplay of various modules in practical implementation of an Offsurance health insurance plan in servicing an Insured Patient in a preferred embodiment.

FIG. 3 is a block diagram illustrating the interplay of various modules as implemented in the administration of an Offsurance health insurance plan in a preferred embodiment.

FIG. 4 is a block diagram illustrating the network architecture integrating the various computer terminals and interfaces to provide a single Offsurance implementation platform of a preferred embodiment.

### DETAILED DESCRIPTION OF THE INVENTION

It is advantageous to define several terms before describing the invention. It should be appreciated that the following terms are used throughout this application. Where the definition of term departs from the commonly used meaning of the term, applicant intends to utilize the definitions provided below, unless specifically indicated. Therefore, for the purpose of this description the terms used in describing this invention are defined as follows:

### DEFINITIONS

1. Insurance: A form of risk management primarily used to hedge against the risk of a contingent loss. Insurance is defined as the equitable transfer of the risk of a loss, from one entity to another, in exchange for a premium, and can be thought of as a guaranteed small loss to prevent a large, possibly devastating loss.
2. Health Insurance: A form of insurance that pays for medical expenses. It may also include insurance covering disability or dismemberment. In the developed nations, Health Insurance is the norm rather than an exception for average citizens. It may be purchased on a group basis (e.g., by a firm to cover its employees) or purchased by individual consumers or an employer may self-fund the health insurance coverage to his employees. In each case, the covered groups or individuals pay premiums or taxes to help protect themselves from high or unexpected healthcare expenses. By estimating the overall risk of healthcare expenses, a routine finance structure (such as a monthly premium or annual tax) is developed, ensuring that money is available to pay for the healthcare benefits specified in the insurance agreement. The benefit is administered by a central organization, most often either a government agency or a private or not-for-profit entity operating a health plan.
3. Insured, Insurer, Beneficiary, Premium & Policy: An insurer is a company selling the insurance to a person or entity called an insured or an insurance beneficiary who buys the insurance. The insurance rate is a factor used to determine the amount to be charged for a certain amount of insurance coverage, called the premium. An insurance policy is an insurance contract issued by the insurer in consideration of the premium paid by the insured/beneficiary that determines the legal framework under which the features of the insurance contract are enforced. The use of the term “Insurer” or the “primary insurer” in describing the present invention implies the home country insurer or the insurance company operating in the country the beneficiary policy holder resides.
4. Underwriting, Underwriter: A process that an insurer uses to assess the eligibility of a customer to receive the insurer's insurance policy is called underwriting. An insurer therefore is also the underwriter of the insurance policy in the general sense of the term.
5. Offsurance, Offsurer: This is a term not known in prior art, but coined for convenience of expressing the oft repeated novel features in the context of the present invention. The term implies a type of health insurance that minimizes the claim reimbursement and administrative costs by outsourcing the elective components of healthcare system to an offshore location with lower costs, thereby significantly reducing the premium for the amount of coverage. For the purpose of describing the instant invention an insurance company that underwrites offsurance is defined as an “Offsurer.” In other words an Offsurer is the discounting health insurer that pays the claim accruing at a offshore destination hospital in return for a share of the health insurance policy premium that the beneficiary pays to his/her primary health insurer at the home or origin country. An Offsurer is usually but not necessarily an overseas insurance company that operates and is well acquainted with the geographic region where its affiliate caregivers are located. Health insurance is a highly regulated business in almost every country, imposing restrictions on issuance of licenses to operate in trans-national jurisdictions. Since the nature of treatment of elective medical procedures overseas (TEMPO) claim is such that a patient who is insured in an origin country such as US, accrues his or her claim in a hospital in a destination country such as India, Thailand, Singapore so on and so forth. Moreover the already high administrative costs of the primary health insurer make it so expensive to process a claim from overseas hospital that much of the cost benefit of low cost treatment at destination hospital is lost.
6. TEMPO: Treatment of elective medical procedures overseas (TEMPO) is the major and the most essential anchor of the present invention.
7. Home country, Origin Country, Home: The geographical location where the beneficiary patient is permanently resident is the origin country or the home country.
8. Destination country, Offshore: The overseas location where the offshore caregiver is located.
9. Home Caregiver: The term refers to the home country healthcare infrastructure that includes hospitals and their staff participating in providing the required services to the patients.
10. Offshore Caregiver: The term refers to the destination country healthcare infrastructure that includes hospitals and their staff accredited and certified by at least one of the internationally recognized health care evaluators. Examples of such accreditation agencies include US based Joint Commission International (JCI), UK based Trent Accreditation Scheme, Australian Council for Healthcare Standards International (ACHSI), Canadian Council on Health Services Regulation (CCHSA) so on and so forth. The term as used in describing the present invention may also incorporate the business process outsourcing (BPO) components that support health insurance administrative and other ancillary support services in implementation of the various offshore modules of the invention's network architecture.
11. Actuary: Insurance companies employ mathematicians, called actuaries, who study and compile statistical data about exposure units and risks. An exposure unit is the person or item of property that is insured. In order for the law of large numbers to be effective, a large number of similar, or homogeneous, exposure units must be combined. For health insurance purposes, the exposure unit is equivalent to the economic value of the insured person's health. This data is the basis for the mortality (death) and morbidity (sickness) tables that are used to predict probable future losses due to sickness and death. Of course, these tables take into account many different variables which raise or lower the risk of loss. The insured person is classified, and premiums are set, based upon where his or her profile falls with regard to these tables.
12. Beneficiary, Patient: The term “patient” or “beneficiary” as used herein is not only referencing a party who is being treated, but is intended to encompass any person or legal entity that might stand in the place of the actual person for whom the medical services are being provided, i.e., the party who will be obligated to pay the portion of the billed services not being reimbursed by the insurer.

### DESCRIPTION

There are various models of health plans. In one model the health insurer pays for all of the member's health services in particular agreed categories up to a predetermined limit. This predetermined limit is the limit of the health insurer's liability. In an alternative model, a member has a personal medical fund or medical savings account or any other similar fund governed by respective healthcare and tax legislation, which is managed by the health insurer or third party administrator of the health plan, but which the member and/or the member's employer funds. Any health related claims made to the health insurer are then paid by the health insurer or third party administrator from this personal medical fund up to a predetermined amount. Only after the predetermined amount does the health insurer incur liability and pay for the covered health related costs up to another predetermined amount. In yet another model the health insurance plan is entirely funded and operated by the employer without involving a health insurance company. No matter which model is deployed the network architecture of the instant invention seamlessly integrates the cost reducing offshored elements into the insured's health plan.

Insurance premiums are determined by actuaries employed by insurance companies. The cost of advertising, selling, paying for services rendered by health care practitioners, administration of the insurance program as well as the investment of premium payments and a profit margin are factored into the premium amount. Actuaries determine the exposure to risk according to the provisions of the insurance policy and then set a premium rate. Additional underwriting factors, such as adverse selection for individual policies and special industry exposures for employer-sponsored group health insurance plans, are also factors of the premium charged.

Often the premium charged on an individual plan is much higher than the premium charged for similar coverages offered through a group plan due to “adverse selection.” Under group plans, an insurance company can determine that a percentage of participants will generally be in good health. Under individual plans, it is more likely that people in poor health and having a greater need for insurance will seek to buy coverage, therefore “adverse selection” is the result of the basic premise that those people in good health do not have as much need for insurance as people who are in poor health.

Elective medical procedures performed on the patients are the major contributors to a high risk ratio for Health Insurance companies. With these procedures outsourced overseas the insurance companies can significantly improve the risk ratio consequently resulting in lowered premiums. Outpatient care and physician time, as compared to the rest of the world is overused in US, which can be significantly reduced by offshoring 24/7 online physician service to a destination country. The prescription drug costs in US are significantly higher than other countries, which can also be reduced by home delivery of chronic care medications via online prescriptions to an online pharmacy. Finally and most importantly, as much as 33% or more of the premium revenue is spent in insurance administration and other administrative costs. Outsourcing of such administrative processes offshore will also bring that cost down.

The method, apparatus, modules and interfaces described herein can be realized in hardware, software, or a combination thereof in a distributed fashion where different elements are spread across several interconnected computers in a network. Any kind of computer system or other apparatus adapted for carrying out the methods described herein can be deployed to implement the present invention. Combination of some conventional processes with several new processes, that result in seamless integration of disparate outsourced elements of healthcare to significantly lower insurance premiums or member contributions, are illustrated. They may also be used to minimize the costs of self-funded employee healthcare programs of companies and other consumer driven healthcare programs.

From the perspective of fiscal management of an insured healthcare system there are 3 basic components that contribute to pricing of a health insurance plan: 1) Underwriting of the plan; 2) Implementation of the plan, and; 3) Administration of the plan. The instant invention uses plurality of computer modules to innovate each of these components to bring the cost significantly down to 50% or more as compared to the conventional health insurance plan. For better understanding the logistics are described first followed by the apparatus that enables the invention.

### Underwriting

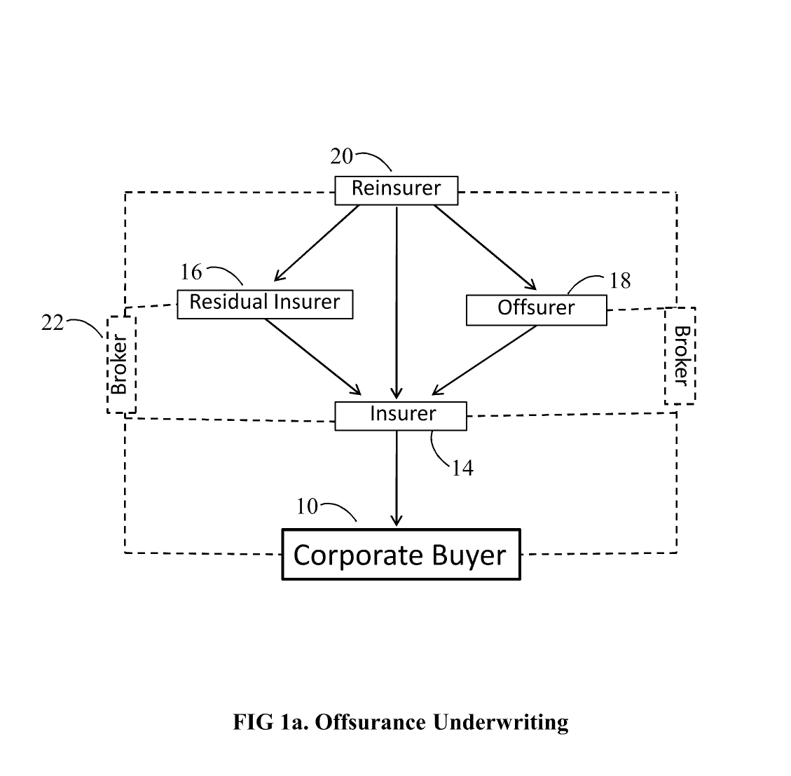

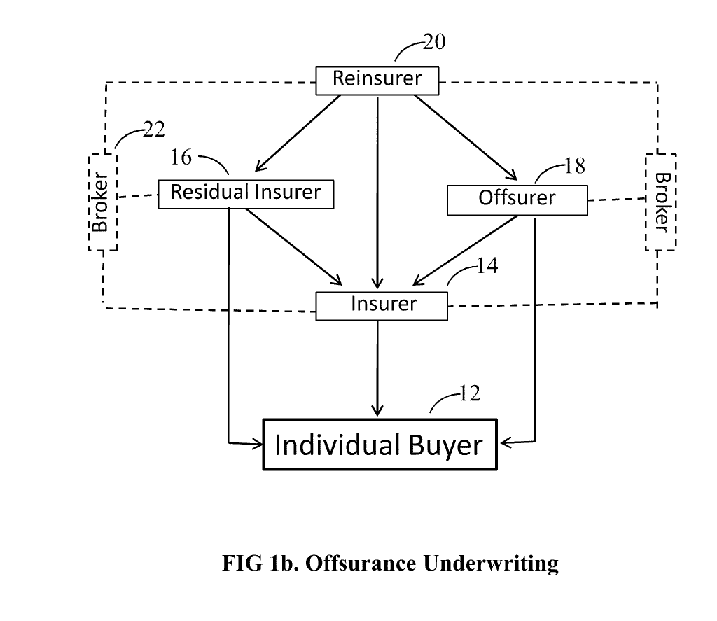

As illustrated in FIG. 1a and FIG. 1b, the Offsurance underwriting is implemented through at least five computer modules comprising of the Corporate 10 or the Individual Buyer 12, the Insurer 14 (first insurer), the Offsurer (second insurer) 16, the Residual Insurer (third insurer) 18, the Reinsurer (fourth insurer) 20 and the Broker 22. For a practical implementation of the invention, all five modules may be utilized or functions of these modules may be merged into two or more modules. The primary insurer using the first insurer computer terminal retrieves beneficiary profile information from the central server to estimate health insurance premium using the standard actuarial algorithms for the qualifying beneficiary and underwrites the primary health insurance policy. Before providing the final quote to the beneficiary the premium of such policy is processed by the Offsurer module to provide further discount in lieu of outsourcing the policy holding beneficiary patient's treatment of all elective medical procedures to accredited low cost caregivers offshore affiliated to that specific underwriting Offsurer.

The beneficiary may also use Residual Insurer (third insurer) who uses computer module 18 to underwrite the residual insurance covering, travel, hospitality and procedure related to risks occurring during the course of patient's travel to foreign destination country, return home safe from treatment and recurrence of the ailment within one year of the performed treatment. All the three insurers may also benefit from the reinsurance module wherein a fourth insurer (Reinsurer) may insure the risk of policies underwritten by the first, second and third insurer, based on the relevant actuarial metrics retrieved from the central server and analyzed by their own actuarial algorithms. However, the Offsurance Corporate Buyer may also directly interface with only one of them in addition to the Broker 22 (FIG. 1a), and the Individual Buyer may directly interface with the Insurer 14, the Residual Insurer 16 and the Offsurer 18 without having to interface with the Broker 22 (FIG. 1b). Thus the beneficiary, whether corporate or individual, using a computer terminal purchases the low cost health insurance plan by paying the net discounted premium resulting from the actuarial calculations of the first, second and third insurer in case all three underwriters are involved, in addition to brokers commission if a broker is involved. All the insurance underwriting steps, as described in more detailed subsequently, are implemented seamlessly and in real time using the computer terminals, which are interconnected with each other through the five aforementioned underwriting modules that use the actuarial algorithms and methods known to the prior art.

In practical implementation of another embodiment of the method a single health insurer may underwrite the Offsurance Plan that covers the plan beneficiaries for all inpatient emergencies and outpatient services at a home country caregiver location, and inpatient elective medical procedures and back office support at offshore caregiver locations. Such an embodiment can be practically underwritten as a tax deductible Health Savings Account (HSA) plan, wherein the low premium high deductible policy pays or reimburses only all major pre-approved elective medical procedures performed in an offshore location by accredited caregivers and also pays a fixed amount for medical emergencies, leaving all remaining inpatient, outpatient and prescription services at the expense of the beneficiary either from the his/her personal account or HSA account.

In yet another embodiment of the Offsurance Plan a low cost self-funded health insurance plan or a Health Reimbursement Arrangement (HRA) or a combination therein may be operated by an employer instead of an insurance company, in which case the employer may still contract an insurer for stop-loss insurance or residual insurance using the employer module of the present invention.

### Implementation

In the present method all emergency inpatient services to the beneficiary patient at select affiliate hospitals close to beneficiary's location in home country, while all preapproved inpatient elective medical services to the beneficiary patient are provided at accredited and approved hospitals overseas at beneficiary's elected destination country. The implementation of the invention also includes all travel and hospitality related services to the patient during the course of the patient's overseas treatment and return home, whether as fully paid service under the terms of the health insurance policy or whether through pre-agreed co-payments. Clinical outpatient physician services to patients are initially provided through an online physician located at an offshore location, and if necessary subsequently through a visit to beneficiary's home country physician at a geographical location near the beneficiary's place of residence. For acute care, the method prescription drugs from local pharmacy. However, the method also provides to the chronic care patient, wherever applicable, low cost importation and home delivery of prescription drugs from online pharmacy approved by the regulatory authorities. The apparatus for such implementations is further described in detail herein as follows.

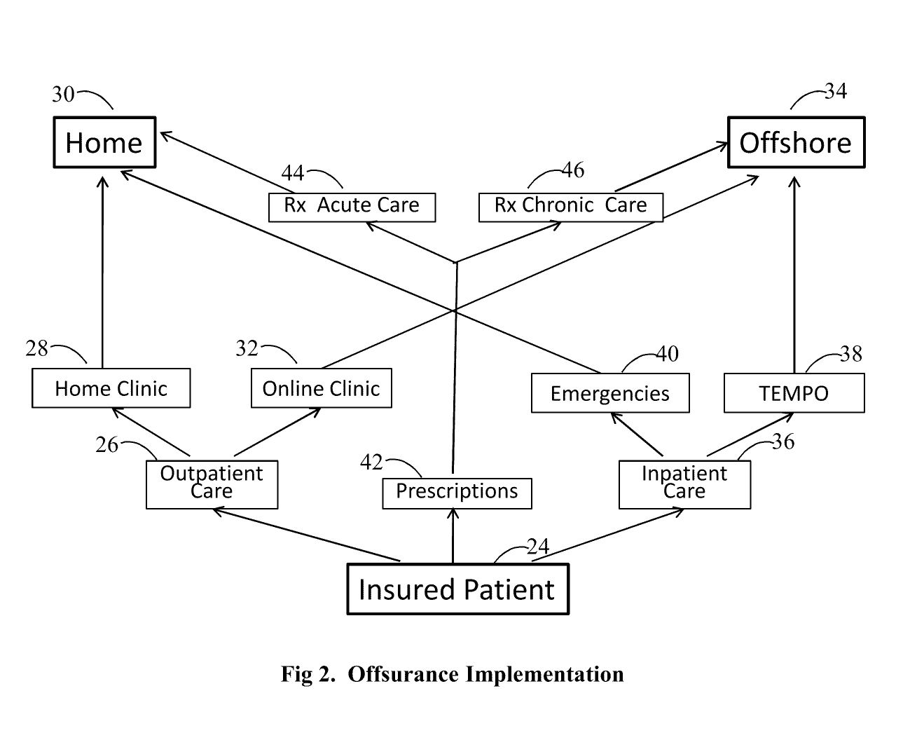

FIG. 2 illustrates the Offsurance implementation strategy in one embodiment. Patient services can be broadly of three types, the inpatient care, the outpatient care and the prescription drugs. While the Insured Patient 24 is authorized to access Outpatient Care 26 through Home Clinic 28 in the Home Country 30, the Offsurance implementation nevertheless provides infrastructure to minimize the expensive Home Clinic visits by providing Online Clinic 32 support that takes care of most basic outpatient needs of the beneficiary patient. Such online clinics are staffed 24/7 by licensed medical practitioners at accredited Offshore 34 locations and specifically trained to service and communicate with the targeted home country patients in patient's own language. The Inpatient Care 36, mostly comprises of elective medical procedures 38 which are usually scheduled within days or weeks, and therefore can be outsourced Offshore 34. The Emergencies 40 as reported in literature may consume less than 2% hospital days of all inpatient paid by the insurance companies (Rosenberg S N et al. Effect of Utilization Review in a Fee-for-Service Health Insurance Plan. N Engl J Med. Nov. 16, 1995;333(20):1326-30), obviously instantly serviced at the Home location 30. For additional cost savings the Offsurance platform also provides for the Prescriptions module 42, which distinguishes the patients on Acute Care 44 versus patients on Chronic Care 46. The acute care patients receive their medications from a Home 30 pharmacy location. Nevertheless it is the chronic care which takes a major share of the prescription drug expense, and offers significant savings by having them home delivered to patients from an Offshore 34 online pharmacy approved by the home country regulatory authorities.

### Administration

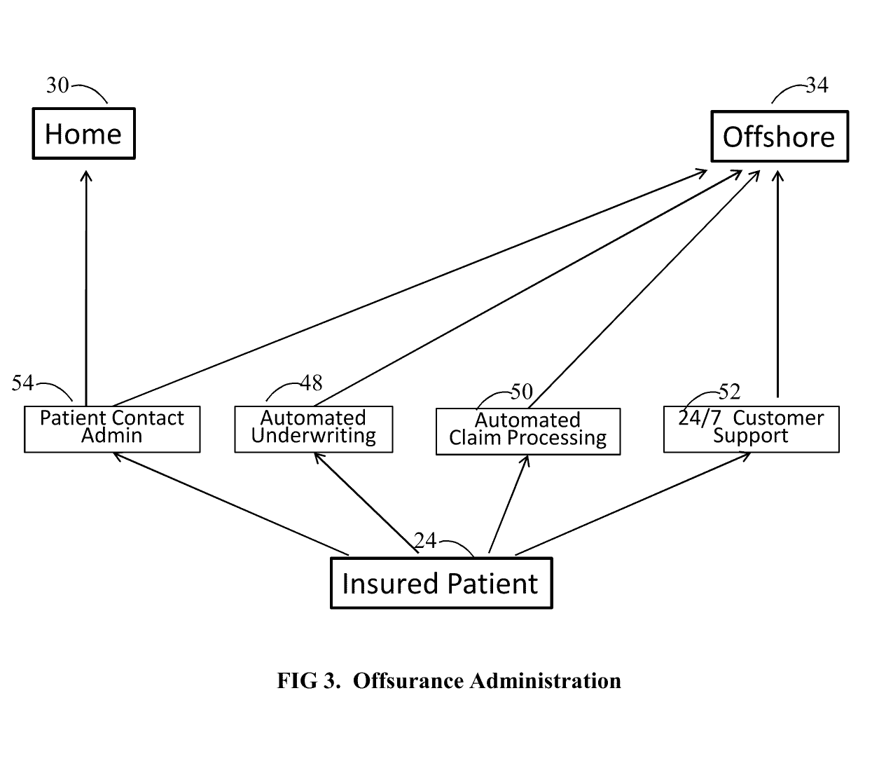

FIG. 3 illustrates the Offsurance administration strategy. Administrative expenses constitute the biggest chunk of every dollar spent on insured healthcare. Offsurance administration cost saving strategy is implemented through four administrative modules, three of which, Automated Underwriting 48, Automated Claim Processing 50, 24/7 Customer Support 52, can be outsourced virtually 100% to an offshore location and the fourth, Patient Contact Administration 54, at least partially. The physician and hospital staff time in home country hospital is minimized by processing administration of patient-caregiver contact online at an offshore 34 destination country, utilizing specially trained low wage personnel. The underwriting and claim processing is automated and performed online by especially trained low wage personnel at a foreign destination country to minimize the paperwork and the home country processing resources. Thus using the method of the present invention all administrative functions except portions of home country patient contact administration, are outsourced to foreign destination country saving significant in health insurance premiums.

Assuming the aforementioned processes of underwriting, implementation and administration of the health insurance plan of the instant invention are outsourced to a destination country such as India from a home country such as United States, the cost savings may be more than 50% over a standard health insurance plan premium available in the home country.

### IT Infrastructure & Offsurance Apparatus

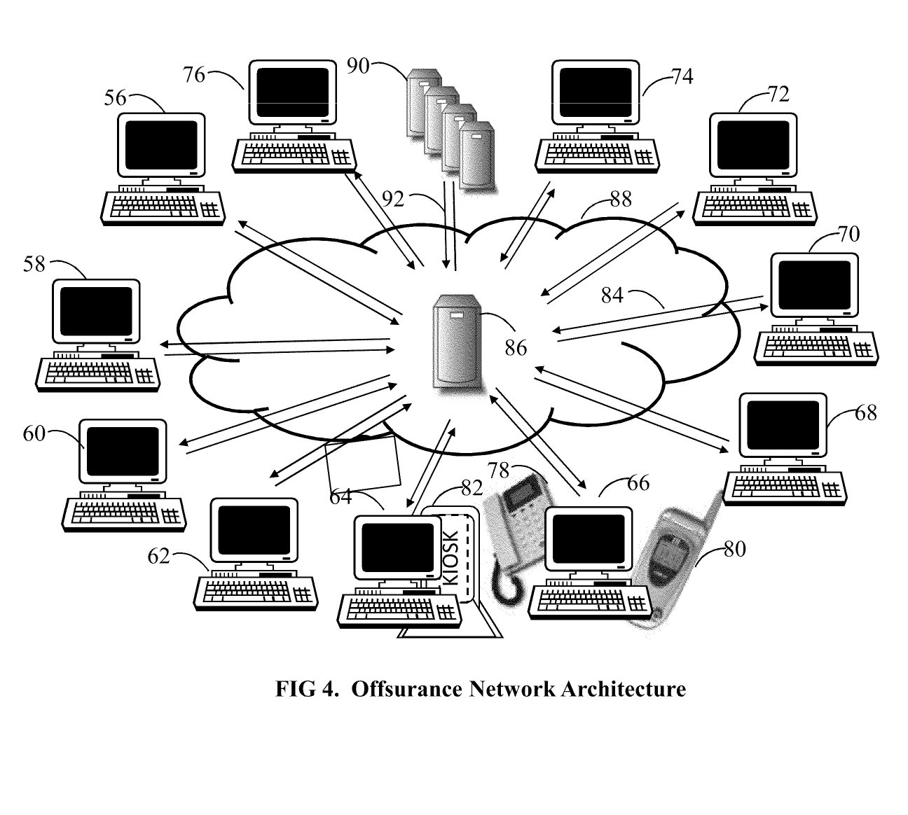

From the perspective of an IT infrastructure the aforementioned underwriting, implementation and administration of the instant invention that reduces the very high cost of healthcare in home countries can be described in terms of a network of multiple modules each of which has its own software and hardware specifications, and each define functionality of fairly diverse nature. The number of such modules may increase or decrease by combining one or more modules or by dividing a module into multiple modules or sub-modules depending on the complexity of the Offsurance plan deployment. However, one embodiment of the instant invention illustrated in FIG. 4, is described here in terms of the following 11 modules interacting with each other through the central server in a

### Client-Server-Client Network Architecture:

The first computer terminal 56 is used by the first health insurer in the home country, who underwrites the primary health insurance policy by means of standard actuarial algorithm based on the beneficiary profiles retrieved from the central server.
The second computer terminal 58 is used by the second health insurer/offsurer, whose underwriting module automatically discounts the primary health insurance policy premium in lieu of outsourcing at least patients' elective medical procedures and administrative support to a foreign destination country.
The third computer terminal 60 is used by the third health insurer, who may underwrite the residual insurance, covering travel and treatment related risks occurring during the course of patient's travel, return home from treatment, accidental death or dismemberment while in the overseas hospital, complication, aftercare/recurrence within one year.
The fourth computer terminal 62 is used by the underwriting broker, who brokers the underwriting deal between the first, second and third insurer and the corporate beneficiaries.
The fifth computer terminal 64 is used by the corporate beneficiary, who either buys group insurance for the company employees from the first health insurer, or self-funds the employee health insurance.
The sixth computer terminal 66 is used by the beneficiary patient, whether an employee of a corporate beneficiary or a privately insured individual.
The seventh computer terminal 68 is used by the home country caregiver that is the primary healthcare infrastructure at beneficiary patient's home country.
The eighth computer terminal 70 is used by the offshore caregiver that is an accredited and approved offshore healthcare infrastructure located at the destination country.
The ninth computer terminal 72 is used by the prescription drug dispensing and home delivery pharmacy that is approved by the home country regulatory authorities.
The tenth computer terminal 74 is used by the back office administration facilitator and customer support center geographically located at an offshore location.
The eleventh computer terminal 76 used by the travel & hospitality facilitators.

Each of the aforementioned computer terminals comprises of either a single computer or a plurality of computers or wired 78 or wireless 80 telecommunication devices, kiosks 82, networked in a wired or wireless local area network (LAN), or a wide area network (WAN), or a virtual private network (VPN), or an Intranet, or Internet. The computer terminal may be a wired computer or a wireless hand held device running an Internet browser application that displays a graphic user interface for secure login of each of the members of the eleven groups subscribed to one of the computer terminal. The client interface may be custom made for that particular device terminal or an active server page displayed in Web browser. Using the client interface the user connects 84 securely, after user authentication, to a central computer server 86 by means of Internet 88 or via telecommunication link or a combination thereof to implement the method by executing the user desired database transaction. Such a central computer server is the transaction server that interfaces each of the eleven client interfaces with plurality of client databases 90. The access 84 by the clients to the central server is secured by means of the authorized user's ID and password deploying any of the security protocols known to the prior art for authentication and data transfer. The connectivity 92 between the central computer server and the plurality of client database servers is also secured by known security protocols such as 128 or 256 bit Secure Socket Layer (SSL) encryption.

Each of the aforementioned computer terminals is operated by means of a corresponding user interface displayed on the corresponding computer terminal that is interfaced with the central server through its corresponding software module. The user interface and the computer terminals may vary in different embodiments. For example in one embodiment the user interface can be a generic graphical user interface such as an Internet browser, while in another it can be a custom computer installable application specifically developed to implement the methods described herein. Nonetheless, the invention is not so limited and any other suitable types of user interfaces can be used. For example, in another embodiment some of the user interfaces can be speech based. In such an arrangement the corresponding client-server application includes speech recognition and/or text-to-speech synthesis known to the skilled in the art. Similarly the invention does not limit the client hardware to the traditional computers, but depending on client circumstances can include a kiosk 82, wired telecommunication device 78, or a wireless hand held computer, or a wireless handheld telecommunication device 80.

Authorized users of each of the client interfaces are updated on a regular basis by the central server's membership application, which can update the list of the registered users of each of the eleven modules. For example, users can be added, modified or deleted in real time. The method can begin in a state in which a user of a client interface, for example a patient beneficiary 66, has been authenticated and a user session has been established between a client and a server. Patient logs in to review the status on his angioplasty procedure that his primary physician 68 at home country destination has advised. The patient is offered to chose from caregiver destinations and set up an appointment with the destination clinician 70. As the patient chooses the country, the city, the hospital, the doctor from the accredited destination caregiver and selects a probable date for the treatment, the rest of the implementation modules are automatically updated and alerted. For example the insurer 56 and offsurer 58 are simultaneously alerted by the central server 86 as the patient appointment request is delivered to the selected caregiver 70, who on acceptance of the appointment request gets access to the medical records of the patient. Once the insurer/offsurer authorize the treatment at the specific offshore caregiver location 70, the affiliate airline and hotel options are automatically made available to the patient for making appropriate reservations for the travel to the destination country hospital. After the patient has made hotel bookings and airline reservations, the travel/hospitality terminal 76 sends an authorization request to the Offsurer 58. The Offsurer authorizes payment and patient receives his confirmed itinerary from the travel/hospitality terminal 76. The patient can anytime contact the 24/7 customer support 74 for all of his health related queries before, during or after his medical treatment. The personnel at terminal 74 located offshore perform all administrative and logistic functions involved in customer support, claim processing, payment processing and interfacing with each one of the modules involved in the care delivery process. The caregiver 70, after treating the patient invoices and gets paid by the Offsurer 58. If there are any deductibles or copayments due to be paid, the patient directly pays to service component that is directly subject to such deductibles.

Instead of using a computer terminal 66 the patient may alternatively communicate with the system via the central server 86 using a telephone 78 or a mobile phone 80 or the kiosk at his employment location 82 for availing his entire healthcare related needs. Thus a patient beneficiary's Offsurance plan takes care of the total experience commencing from offshore caregiver appointment to return back home.

For a clinician at the offshore location where the patient has opted to get his angioplasty procedure done, the method can begin in a state in which the user of the client interface is a clinician using the offshore caregiver terminal 70 is authenticated and a user session is established between the client and the central server 86. The application initiated on the central server delivers to the client the updated information on a new request for angioplasty appointment for initial consultation and procedure scheduling. The clinician may also retrieve, from the central server 86, all the clinical information on the patient and accordingly further interact with the patient or schedule the procedure.

In a similar manner each of the remaining computer terminals deploy their corresponding client interfaces for performing their corresponding functions pertaining to the action initiated by the patient regarding his angioplasty procedure. Such functions include scheduling, counseling, patient record transfer, travel arrangements, airport transfers, claim processing, co-payment realization, customer support so on and so forth.

Further implemental intricacies of the method of the instant invention can be elicited through the illustration of the following practical examples.

### EXAMPLE 1

### Current Fully Insured with Fixed TEMPO Credits and Variable Deductibles

In one embodiment a home country health insurance company 14 that currently offers family coverage in a group insurance for a premium of $12,000 per annum, offers its members an option for treatment of elective medical procedures overseas in consideration for a $6,000 discount over the annual premium and a variable deductible based on whether the member chooses a Tier 1, 2 or 3 offshore caregiver. The discount is underwritten by the offsurer 18. Tier 1 caregiver being most expensive of the three and Tier 3 being the least expensive of the three. If the buyer (whether corporate 10 or individual 12) chooses Tier 1 his deductibles are highest as compared to Tier 3, which is the lowest.

### EXAMPLE 2

### Current Fully Insured with Variable TEMPO Credits and Fixed or No Deductibles

In another variant of the Example 1, the TEMPO credits may be variable and the deductibles may be fixed or may be zero. In this situation the member pays lower upfront premium of $6,000, $5,000 or $4,000 based on the variable pre-selection of the corresponding offshore caregiver at Tier 1, 2 or 3. The deductibles in this case are fixed or waived depending on the offsurance terms.

### EXAMPLE 3

### Current Uninsured Buying Coverage from One of the Home Country Health Insurance Companies

In US there are estimated 47 million uninsured, some by choice others by circumstances. At least 20% of uninsured Americans fall in high income group still opting not to pay the high health insurance premium. Very low premium and an opportunity for a paid vacation in an exotic country is the perfect motivation for all categories of uninsured, whether high income or low income group. The home country may offer either:
i) Comprehensive Offsurance Policy, which pays not only the TEMPO claims, but also covers basic outpatient and emergency services at the local hospitals. While the TEMPO claims are underwritten by the home country insurance company's offshore partner firm 18, and the rest of the coverage is underwritten in-house 14 by the home insurer.
ii) TEMPO Only Policy, which covers on the TEMPO claims, underwritten by home insurance insurer's 14 offshore partner 18, and the rest is paid by the beneficiary 12. Since it is the major elective procedures that are usually catastrophic leading to bankruptcies and home foreclosures, such a policy costs very little but still protects against such devastating risks of being uninsured.

### EXAMPLE 4

### Current Uninsured Buying Coverage from One of the Offsurance Underwriters

Just like the previous example, both Comprehensive and TEMPO Only policies may have the same features and benefits, except that the beneficiaries 14 directly purchase them from the Offsurance underwriter 18.

### EXAMPLE 5

### Offsurance as HDHI Plan

In 2004 US Congress enacted legislation establishing tax advantaged health savings accounts (HSA) to be coupled with high-deductible health insurance (HDHI) plans. HSA-eligible HDHI plans typically have lower premiums than traditional health plans and HSAs allow account holders to accumulate tax-free savings to pay for medical expenses. However, some critics are concerned that HDHI plans may attract enrollees who seek lower premiums but lack the resources to contribute to an HSA, and wealthy enrollees who may seek to use the HSA primarily to accumulate tax-advantaged savings rather than pay for medical expenses. In both scenarios Offsurance plan brings additional cost saving and further advantage of using vacation savings as tax-deductible HSA co-payment for combining vacation with medical travel to the destination country. Offsurance will thus increase the utilization of the HSA for the purpose that it was originally legislation by the US Congress, and in the process increase the health insurance coverage to a large proportion of uninsured or inadequately insured Americans.

### EXAMPLE 6

### Employer's Self-Funded Health Reimbursement Arrangements (HRA)

HRAs are one of the fastest growing health care insurance strategies being offered by employers today. The employer is not required to prepay into a fund for reimbursements, instead, the employer reimburses employee claims as they occur. Reimbursements of qualified claims are tax-deductible for the employer. Employees do not have to be covered under any other health care plan to participate, unlike (for example) a Health Savings Account (HSA) which requires a High Deductible Health Plan. Contributions that employers make can be excluded from employees' gross income. Reimbursements may be tax free if the employee pays qualified medical expenses. Unused funds in the HRA can be rolled into future years for reimbursement. Offsurance is an excellent mechanism through which employers can operate HRAs to bring down the net cost of insuring their employees against catastrophic healthcare events

### EXAMPLE 7

### Employer's Self-Funded Health Insurance Plan

Self-funded health care is described as a self-insurance arrangement whereby an employer provides health or disability benefits to employees by assuming the direct risk for payment of their claims for benefits. The terms of eligibility and coverage are set forth in a plan document which includes provisions similar to those found in a typical group health insurance policy. Offsurance again can play a crucial role in significantly bringing down the cost of operating an employer's self-funded health insurance plan.

### EXAMPLE 8

### Insurance against Recurrence

Certain medical conditions are prone to recurrence. In most such cases the home insurance companies may render the patients uninsurable or raise their premiums very high. Offsurance plan responds to this unmet need by offsurer underwritten insurance that insures the beneficiary from recurrence of medical conditions that were already treated overseas under the same ofsurer's policy. Thus such uninsurable conditions get insured against future events at a much lower premium.

In the above description of a preferred embodiment of the present invention several illustrations and examples describe the integration of the conventional processes with new processes that allow seamless implementation of the invention. While there have been shown and described and pointed out fundamental novel features of the invention as applied to preferred embodiment thereof, it will be understood that various omissions and substitutions and changes in the form and details of the disclosed invention may be made by those skilled in the art without departing from the spirit of the invention.

The present invention has been shown in the described embodiments and examples for illustrative purposes only. Further, the terms and expressions which have been employed in the foregoing specification are used as terms of description and not of limitation, and there is no intention, in the use of such terms and expressions, of excluding equivalents of the features shown and described or portions thereof.

What I claim as my invention is:

1. A method, apparatus and computer network of plurality of devices communicating with the central server for effectuating the outsourcing to an offshore location of the process of underwriting, implementation and administration of a low premium health insurance plan (hereinafter “offsurance” “offsurance plan” or just “plan”) for the subscribing policy holders of an origin country (also referred as “home country”), who are the direct beneficiaries of the plan's comprehensive healthcare services, including those pertaining to all major elective medical procedures provided by accredited and authorized healthcare service providers elected by the beneficiary and located in a foreign destination country (also referred as “offshore location”), such service providers' qualified and approved services rendered to the beneficiary from the time the beneficiary leaves home country, gets treatment for his/her medical condition in the destination country and returns home, are directly paid or reimbursed by such offsurance plan.

2. The computer network of claim 1, wherein the seamless and automatic offsurance plan underwriting process comprises of the following steps:
a. a first health insurer using a computer terminal accesses and retrieves beneficiary profile information from the central server to estimate the health insurance premium using the standard actuarial algorithms for the qualifying beneficiary and underwrites the primary health insurance policy;
b. a second health insurer using a computer terminal access and retrieves beneficiary profile and matches offshore caregiver to underwrite the discount offered over the primary health insurance policy premium in lieu of outsourcing the policy holding beneficiary patient's treatment of all elective medical procedures to accredited low cost caregivers offshore affiliated to the second health insurer;
c. a third insurer using a computer terminal underwrites the residual insurance covering travel, hospitality and procedure related to risks occurring during the course of patient's travel to foreign destination country, return home safe from treatment and recurrence of the ailment within one year of the performed treatment;
d. a fourth insurer using a computer terminal may reinsure the insurance coverage underwritten by the first, second and third insurer based on the relevant actuarial metrics retrieved from the central server and analyzed by its own actuarial algorithm;
e. the underwriting broker using a computer terminal brokers the underwriting deal between the first, second and third insurers and the corporate beneficiaries;
f. the corporate beneficiary or the individual beneficiary using a computer terminal purchases the low cost health insurance policy by paying the net discounted premium resulting from the actuarial calculations of the first, second and third insurer; and,
g. alternately, a single health insurer may underwrite the offsurance plan which covers all inpatient emergencies and outpatient services at a home country caregiver locations, and inpatient elective medical procedures, travel, hospitality, procedure related risks and back office support at offshore caregiver locations.

3. The computer network of claim 1 wherein the implementation of the offsurance plan comprises of:
a. providing all emergency inpatient and bare minimum outpatient services to the beneficiary patient at select affiliate hospitals close to beneficiary's location in home country;
b. providing all preapproved inpatient elective medical services to the beneficiary patient at accredited and approved hospitals overseas at beneficiary's elected destination country;
c. providing all travel and hospitality related services to the beneficiary patient during the course of the patient's overseas treatment and return home, whether as fully paid service under the terms of the health insurance policy or whether through pre-agreed co-payments;
d. providing clinical outpatient physician services to the beneficiary patient initially through an online physician located at an offshore location, and if necessary subsequently through a visit to beneficiary's home country physician at a geographical location near the beneficiary's place of residence;
e. providing, facilitating or reimbursing to the patient beneficiary low cost importation and home delivery of prescription drugs from an online pharmacy approved by the home country regulatory authorities.

4. The computer network of claim 1, wherein the outsourced administration of the offsurance plan comprises of:
a. automated claim processing at a foreign destination country utilizing specially trained low wage personnel;
b. minimizing the physician and hospital staff time in home country hospital by processing administration of patient-caregiver contact online at a foreign destination country utilizing specially trained low wage personnel;
c. an automated underwriting process that minimizes paperwork and reduces man hours;
d. a 24/7 online customer support center located at the foreign destination country utilizing specially trained low wage personnel.

5. The method of claim 1, wherein the offsurance plan is a low cost self-funded health insurance plan or a Health Reimbursement Account or a combination therein operated by an employer instead of a health insurance company, which provide the employees with coverage for all inpatient emergencies and outpatient services at a home country caregiver locations, and inpatient elective medical procedures and back office support at offshore caregiver locations.

6. The method of claim 1, wherein offsurance plan is a low premium high deductible policy that only pays or reimburses all major pre-approved elective medical procedures performed in an offshore location by accredited caregivers and also pays a fixed amount for medical emergencies, leaving all remaining inpatient, outpatient and prescription services at the expense of the beneficiary either from the his/her personal account or tax deductible health savings account.

7. A computer network of plurality of computer terminals implementing a novel method of reducing up to over 50% the very high cost of healthcare delivery prevalent in the origin countries (also referred as “home countries”) in the developed world, by means of outsourcing components of healthcare that include insured elective medical procedures performed on beneficiary patients by qualified clinicians in offshore accredited hospitals, back office administrative support, customer support, online physician support, and support for importation and home delivery of prescription drugs approved by the home country regulatory authorities, to caregivers in the foreign destination countries (also referred as “offshore”) in the developing world that provide quality healthcare services at a very low cost comprising some or all of the following elements:
a. the first computer terminal used by the first health insurer in the home country, who underwrites the primary health insurance policy by means of standard actuarial algorithm based on the beneficiary profiles;
b. the second computer terminal used by the second health insurer (also referred as offsurer), who underwrites the discount offered over the primary health insurance policy in lieu of outsourcing at least the elective medical procedures performed on the beneficiary patients and administrative support to a foreign destination country;
c. the third computer terminal used by the third insurer, who underwrites the residual insurance covering travel and treatment related risks occurring during the course of patient's travel, return home from treatment, accidental death or dismemberment while in the overseas hospital, complication, aftercare/recurrence within one year;
d. the fourth computer terminal used by the underwriting broker, who brokers the underwriting deal between the first, second and third insurer and the corporate beneficiaries;
e. the fifth computer terminal used by the corporate beneficiary, who buys group insurance for the company employees from the first health insurer, or a self-funded health insurance plan employer, or a health reimbursement account holding employer;
f. the sixth computer terminal used by the beneficiary patient, whether an employee of a or a privately insured individual;
g. the seventh computer terminal used by the home country caregiver that is the primary healthcare infrastructure at beneficiary patient's home country;
h. the eighth computer terminal used by the offshore caregiver that is an accredited and approved offshore healthcare infrastructure located at the destination country;
i. the ninth computer terminal used by the prescription drug dispensing and home delivery pharmacy that is approved by the home country regulatory authorities;
j. the tenth computer terminal used by the back office administration facilitator and 24/7 customer support center geographically located at an offshore location;
k. the eleventh computer terminal used by the travel & hospitality facilitators; each of such computer terminals, which comprises of either a single computer or a plurality of computers or telecommunication devices running an Internet browser or a custom application that displays a graphic user interface for secure login by means of user ID and password enabling each of the user group to securely access the database located at the central data processing center for completing the desired database transaction using a wired or wireless local area network (LAN), or a wide area network (WAN), or a virtual private network (VPN), or an Intranet, connect securely deploying SSL protocol after user authentication to a central transaction server by means of Internet or via telecommunication link or a combination thereof to implement the method by executing the user desired database transaction.

8. The method of claim 7, wherein the offsurance plan is a low cost self-funded health insurance plan or a Health Reimbursement Account or a combination therein operated by an employer instead of an insurance company, which provide the employees with coverage for all inpatient emergencies and outpatient services at a home country caregiver locations, and inpatient elective medical procedures and back office support at offshore caregiver locations.

9. The method of claim 7, wherein offsurance plan is a low premium high deductible policy that only pays or reimburses all major pre-approved elective medical procedures performed in an offshore location by accredited caregivers and also pays a fixed amount for medical emergencies, leaving all remaining inpatient, outpatient and prescription services at the expense of the beneficiary either from his/her personal account or tax deductible Health Savings Account.
